(19) United States
(12) Patent Application Publication
(10) Pub. No.: US 2011/0223510 A1
(43) Pub. Date: Sep. 15, 2011

(54) Method for Producing an Interconnector for High Temperature Fuel Cells, Associated High Temperature Fuel Cell and Thus Built Fuel Cell Assembly

(76) Inventors: Horst Greiner, Forchheim (DE); Alessandro Zampiero, Erlangen (DE)

(21) Appl. No.: 13/121,792

(22) PCT Filed: Sep. 29, 2009
(86) PCT No.: PCT/EP2009/062635

§ 371 Date: Jun. 2, 2011

(30) Foreign Application Priority Data
Sep. 30, 2008 (DE) 10 2008 049 608.1

(51) Int. Cl. H01M 4/66; H01M 8/00; F27D 7/06; F27D 99/00; H01M 8/24

(52) U.S. Cl. 429/452; 429/535; 432/23; 432/13; 429/533

(57) ABSTRACT

A method for producing an interconnector for high temperature fuel cells, an associated high temperature fuel cell and a fuel cell system are provided. A precisely defined sealing area made of material with good electro-conductive properties is introduced as an interconnector into a metallic porous carrier of a high temperature fuel cell. The material is applied to the carrier in a precisely defined manner and infiltrates into a sintered composite of the carrier material by heat treatment. An interconnector is produced in the fuel cell, wherein the fuel cells are interconnected via the interconnector. Such a fuel cell has a working temperature of between 500 and 700° C.

### CROSS REFERENCE TO RELATED APPLICATIONS

This application is the US National Stage of International Application No. PCT/EP2009/062635 filed Sep. 29, 2009, and claims the benefit thereof. The International Application claims the benefits of German Application No. 10 2008 049 608.1 DE filed Sep. 30, 2008. All of the applications are incorporated by reference herein in their entirety.

### FIELD OF INVENTION

The invention relates to a method for producing an interconnector of a high temperature fuel cell. In addition, the invention also relates to an associated fuel cell and a fuel cell system constructed therewith.

### SUMMARY OF INVENTION

In the context of high temperature fuel cells provided with a solid oxide electrolyte (SOFC=Solid Oxide Fuel Cell), the term interconnector denotes the regions with which the individual fuel cells are electrically contacted in series or grouped in parallel contact. These regions of the SOFC must have good electrical conductivity and be impermeable to gas. In the case of tubular SOFCs, the interconnector consists of a narrow region in the axial direction of the tube-shaped element. In the case of the so-called HPD fuel cells, the interconnector consists of a region of good conductivity inset opposite the functional layers. Specifically for HPD fuel cells based on the Δ-principle, this is the substrate region of the triangularly configured structure.

In the case of the tubular SOFC having a ceramic substrate which likewise implements the cathode, the interconnector consists of a ceramic layer of LaCrO₃ applied by atmospheric plasma spraying. In parallel patent applications of the Applicant having the same priority of filing date, it is proposed to use a porous metal structure as the substrate for the functional layers, said metal structure being specifically the cathode substrate. Porous metal substrate structures of this kind make it possible to lower the operating temperature of the fuel cell system from approximately 1000° C. to a range of between 500° C. and 700° C. The design and provision of the peripheral units is significantly simplified by the reduced operating temperatures.

The porous metal substrate structures can be produced using normal metallurgical processes, e.g. sintering, but also by extrusion or casting. Substrate structures of this kind are then provided with the functional layers and in particular with the interconnector.

An object of the invention is to specify a method enabling defined regions in porous metal structures to be provided with impermeable, electrically conductive contacting elements, thereby creating a suitable high temperature fuel cell and an associated fuel cell system (stack).

This object is achieved by a method, a fuel cell and a fuel cell system as claimed in the independent claims. Further developments of the method and associated fuel cells are set forth in the dependent claims.

The subject matter of the invention is the creation of suitable defined interconnector regions by applying conductive material and corresponding heat treatment. Said conductive materials can be, for example, tapes, pastes or powders. In particular, a precisely defined geometry can be maintained using so-called brazing foil.

The essential aspect of the invention is that the porous metal structure is basically heated to close to the melting point of the applied material. However, the temperature must be high enough to reduce the viscosity of the applied material sufficiently to achieve infiltration into the pores of the porous metal material. The heat treatment can be carried out e.g. under vacuum or reducing atmosphere. By predefining the heat treatment time, the geometry and penetration depth of the brazing material into the porous matrix can be precisely specified. Said penetration and sealing of the pores of the porous metal substrate takes place solely in the regions where the material is applied, thereby enabling a precisely defined and delimited sealing area to be implemented at the required location on the porous metal substrate.

Examples of brazing materials are well-known nickel-, copper- or cobalt-based brazing foils or powders/pastes, but other materials, in particular alloys of these metals, can also be used. Interconnectors can be created in different types of SOFC using this procedure. Considerable savings can be made compared to known ceramic-based SOFC manufacturing processes. Production of the novel interconnector in the metal-based SOFC is simple, cheap, fast and effective.

### BRIEF DESCRIPTION OF THE DRAWINGS

Further details and advantages of the invention will emerge from the following description of exemplary embodiments which will proceed with reference, in conjunction with the relevant claims, to the accompanying drawings, in which:

FIG. 1 shows a sectional view of the structure of an HPD fuel cell,

FIG. 2 schematically illustrates the novel procedure for producing the interconnector and

FIG. 3 shows a micrograph of the porous metal substrate with impermeable interconnector embedded according to the novel method in the transitional region

### DETAILED DESCRIPTION OF INVENTION

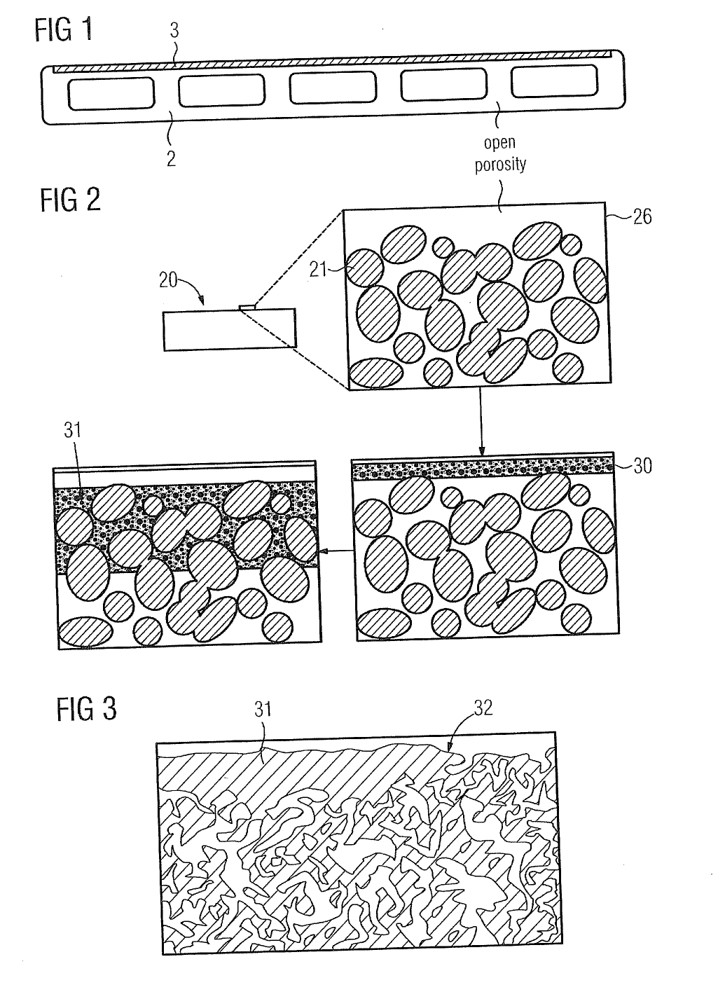

FIG. 1 shows the structure of an HPD fuel cell wherein the individual air ducts are rectangular. The metal substrate is denoted by 2. On one side, the substrate carries the functional layers, i.e. cathode 1, electrolyte and anode, which is not shown in detail in FIG. 1.

In a known manner, the functional layers can each consist of a plurality of layers of matched materials, for which reference is made to the relevant prior art.

By stacking of structures according to FIG. 1, the so-called “bundle” of a fuel cell system is produced, wherein oxygen i.e. air is guided in the essentially rectangular ducts and combustible gas is fed between the cells, for which reference is likewise made to the relevant prior art.

The essential aspect of FIG. 1 is that, in accordance with the proposals of the parallel applications of the Applicant, the substrate structure consists of a porous metal that is permeable to air and/or oxygen. The typical fuel cell reaction can then take place within the solid ceramic electrolyte layer with the liberation of electric charge.

In FIG. 1, an impermeable metal region is inset as an interconnector layer 3 on the top of the substrate 2. The current is transferred from one cell to the next via this region 3.

In the diagram in FIG. 2, the porous metal substrate as the starting point of the described procedure is denoted by 20. According to the enlarged representation, individual particles 21 are present in the metal structure which form a sintered composite during manufacture. This means that open pores are present inside the sintered composite, as is normal with sintered materials. The open porosity is denoted by the reference numeral 26

A brazing foil 30 cut in a defined manner is placed onto the porous sintered compact 20 at the required location. The dimensions of the brazing foil 30 define the subsequent interconnector region. This is followed by heat treatment close to the melting point of the brazing foil, during which the brazing foil material is drawn into the sintered composite where it seals off the porosity present.

The heat treatment takes place in a vacuum or other suitable atmosphere, resulting in a structure in which the region 31 is impermeable and completely electroconductive in a precisely defined manner.

The latter structure is illustrated in the micrographic representation in FIG. 3. Clearly discernible here are the sintered composite of the substrate structure and the, in contrast, precisely defined impermeable metal region 31. In the edge regions 32, there is produced a precise demarcation from the porosity. Contacting of the individual fuel cells can take place via the region 31.

As an alternative to the brazing foil used in FIG. 2, conductive tapes, pastes or powders can also be used. In each case a considerable reduction in production time and therefore also in the costs of the process can be achieved thereby. Precisely defined interconnectors for tubular/HPD or Δ-cells with metal-based substrate are achieved in an automated process step in each case.

As already described, by stacking individual fuel cells and establishing contact via the interconnectors, a novel fuel cell system can be constructed which is characterized by operating temperatures in the range 500 to 700° C.

1.-13. (canceled)

14. A method for producing interconnectors for metal-based high temperature fuel cells, wherein a porous metal structure is the substrate of functional layers consisting of cathode, solid electrolyte and anode, comprising:
providing a porous metal structure and a electrically conductive material;
applying the electrically conductive material to a precisely defined region of the porous substrate structure, wherein a sintered compound is produced; and
sealing the sintered compound by a heat treatment and thereby producing an electrically conductive interconnector.

15. The method as claimed in claim 14, wherein the conductive material comprises a brazing foil of defined geometry and composition.

16. The method as claimed in claim 14, wherein the conductive material comprises an electrically conductive and gas-impermeable tape of defined geometry.

17. The method as claimed in claim 14, wherein the conductive material comprises a conductive paste.

18. The method as claimed in claim 14, wherein the conductive material comprises a conductive powder.

19. The method as claimed in claim 14, wherein the heat treatment is carried out at a temperature below a melting point of the metal structure.

20. The method as claimed in claim 14, wherein the heat treatment is carried out under vacuum conditions to assist the infiltration process.

21. A high temperature fuel cell, comprising:
a cathode and an anode as electrodes;
a solid electrolyte disposed between the electrodes; and
a porous metal structure used as a substrate for the electrodes and the electrolyte, wherein the porous metal structure comprises an interconnector.

22. The high temperature fuel cell as claimed in claim 21, wherein the interconnector is an impermeable metal, electrically conductive region of the metal structure.

23. The high temperature fuel cell as claimed in claim 21, wherein the metal structure is a tubular structure.

24. The high temperature fuel cell as claimed in claim 21, wherein the metal structure is an HPD structure.

25. The high temperature fuel cell as claimed in claim 21, wherein the fuel cell comprises a Δ-design.

26. A high temperature fuel cell system, comprising:
a plurality of fuel cells, each fuel cell comprising:
a cathode and an anode as electrodes;
a solid electrolyte disposed between the electrodes; and
a porous metal structure used as a substrate for the electrodes and the electrolyte, wherein the porous metal structure comprises an interconnector,
wherein the plurality of fuel cells are electrically connected in series to form a bundle, and
wherein the individual fuel cells are contacted via an interconnector with impermeable metallic material.

27. The high temperature fuel cell system as claimed in claim 26, wherein an operating temperature of the fuel cell system is between 500 and 700° C.
